(19) United States
(12) Patent Application Publication
(10) Pub. No.: US 2024/0052975 A1
(43) Pub. Date: Feb. 15, 2024

(54) GREASE-DISCHARGING APPARATUS

(71) Applicant: MAKITA CORPORATION, ANJO-SHI (JP)

(72) Inventors: Hidefumi HAGIWARA, Anjo-shi (JP); Masanori OSHIKA, Anjo-shi (JP)

(21) Appl. No.: 18/366,194

(22) Filed: Aug. 7, 2023

(30) Foreign Application Priority Data
Aug. 10, 2022 (JP) 2022-128280
May 18, 2023 (JP) 2023-082524

(51) Int. Cl. F16N 5/02

(52) U.S. Cl. CPC F16N 5/02

(57) ABSTRACT

A grease gun (1; 1A-1I) includes: a brushless motor (20); a pump (60) configured to be driven or drivable by the motor; a motor-housing part (4), which houses the brushless motor; a pump housing (45), which contains the pump and extends in an up-down direction; a tank (54), which supplies grease to the pump; and a front-tube part (67) provided at a front portion of the pump housing. A front end of the tank is connected to the pump and extends in a front-rear direction that is perpendicular to the up-down direction.

### CROSS-REFERENCE

The present application claims priority to Japanese patent application serial number 2022-128280 filed on Aug. 10, 2022, and to Japanese patent application serial number 2023-082524 filed on May 18, 2023, the contents of both of which are incorporated fully herein by reference.

### TECHNICAL FIELD

The present disclosure relates to a grease-discharging apparatus such as a grease gun.

### BACKGROUND ART

An example of a known grease-discharging apparatus is disclosed, for example, in Japanese Laid-open Patent Publication No. 2021-102989. This grease gun comprises a tank (barrel), which stores grease, a housing, which is connected to the tank, a motor, which is housed in the housing, and a pump, which is driven by the motor. When the motor is driven and thereby causes a plunger of the pump to undergo reciprocating motion, the grease inside the tank is pressurized and discharged (dispensed) from (through) a discharge opening.

### SUMMARY

In the above-described known grease gun, a brushed motor is used as the motive power supply. However, although brushed motors can be manufactured at low cost, there are limitations in the control of the motor output, and therefore it has been difficult in the past to sufficiently increase the motor output to perform high-speed discharge in a high-pressure range.

Accordingly, it is one non-limiting object of the present disclosure is to disclose techniques for increasing motor output so that a grease-discharging apparatus (e.g., a grease gun) is capable of high speed discharge in a high-pressure range.

In one non-limiting aspect of the present teachings, a grease-discharging apparatus may comprise:
a motor;
a pump, which is configured/adapted to be driven or drivable by the motor;
a motor housing, which houses the motor;
a pump housing, which has (contains) the pump and extends in the up-down direction;
a tank, which is configured/adapted to supply grease to the pump; and
a grease-discharge opening, which is provided at a front portion of the pump housing.

Furthermore, a front end of the tank may be connected to the pump and extend in the front-rear direction, and the motor may be a brushless motor.

In another aspect of the present teachings, a grease-discharging apparatus may comprise:
a motor;
a pump, which is configured/adapted to be driven or drivable by the motor;
a motor housing, which houses the motor;
a pump housing, which has the pump and extends in the up-down direction;
a tank, which is configured/adapted to supply grease to the pump;
a grease-discharge opening, which is provided in the pump housing; and
a setting portion for setting a grease-discharge amount (grease-dispensing amount), and/or a display portion, which displays the grease-discharge amount (i.e. the amount of grease to be dispensed).

Furthermore, a front end of the tank may be connected to the pump and extend in the front-rear direction, and the motor may be a brushless motor.

By utilizing techniques disclosed in the present teachings, the motor output can be sufficiently increased so that high speed discharge in a high-pressure range is enabled.

### BRIEF DESCRIPTION OF THE DRAWINGS

FIG. 1 is an oblique view of a grease gun according to Working Example 1 of the present teachings.

FIG. 2 is a side view of the grease gun according to Working Example 1.

FIG. 3 is a center, longitudinal, cross-sectional view of the grease gun according to Working Example 1.

FIG. 4 is an oblique view of the grease gun according to Working Example 2 of the present teachings.

FIG. 5 is a partial, enlarged, plan view of the grease gun according to Working Example 2.

FIG. 6 is a center, longitudinal, cross-sectional view of the grease gun according to Working Example 2.

FIG. 7 is an enlarged view of a panel-holding part shown in FIG. 6.

FIGS. 8A-8C show display examples of an operation panel, wherein FIG. 8A shows a display example of a mode change, FIG. 8B shows a display example of a speed change, and FIG. 8C shows a display example of a discharge amount.

FIG. 9 is an explanatory diagram of the grease gun that shows a first modified example of the layout.

FIG. 10 is an explanatory diagram of the grease gun that shows a second modified example of the layout.

FIG. 11 is an explanatory diagram of the grease gun that shows a third modified example of the layout.

FIG. 12 is an explanatory diagram of the grease gun that shows a fourth modified example of the layout.

FIG. 13 is an explanatory diagram of the grease gun that shows a fifth modified example of the layout.

FIG. 14 is an explanatory diagram of the grease gun that shows a sixth modified example of the layout.

FIG. 15 is an explanatory diagram of the grease gun that shows a seventh modified example of the layout.

FIG. 16 is an explanatory diagram of the grease gun that shows a eighth modified example of the layout.

### DETAILED DESCRIPTION

In one embodiment of the present disclosure:
the motor housing may be disposed upward of the tank and extend in the front-rear direction; and
the motor may comprise a stator, a rotor, which is disposed in the interior of the stator and comprises a rotary shaft, and a sensor circuit board, which detects the rotational position of the rotor, and may be housed in the interior of the motor housing with an orientation such that the rotary shaft extends in the front-rear direction.

According to this configuration, the tank and the motor housing, both of which extend in the front-rear direction, are disposed upward and downward (i.e. in the up-down direction, one above the other), and thereby the left-right width of the grease-discharging apparatus can be made more compact.

In another embodiment of the present disclosure:
a grip part, which extends in the front-rear direction and of which both front and rear ends are connected to the motor housing in a loop shape, may be formed upward of the motor housing; and
a trigger switch, which operates the motor, and a manipulatable member, which pushes in the trigger switch, may be provided in/on the grip part.

According to this configuration, the grip part also extends in the front-rear direction upward of the motor housing and thus is much more compact in the left-right direction. In addition or in the alternative, the grease-discharging apparatus also can be easily manipulated, handled, controlled, etc. using the grip part, which is located upward.

In another embodiment of the present disclosure:

A battery-holding part (battery mounting part), on which a battery pack is mounted (mountable), may be formed at/on a coupling portion at which rear ends of the motor housing and the grip part are coupled to each other; and
a controller, which controls the motor based on one or more detection signals of (from, output by) the sensor circuit board, may be housed in the interior of the battery-holding part.

According to this configuration, front-rear balance is improved, and handling of the grease-discharging apparatus becomes easier.

In another embodiment of the present disclosure, the controller may be capable of changing the discharge (dispensing) speed of the grease output (dispensed) by the pump by controlling the rotational speed of the rotary shaft based on the push-in amount of the trigger switch caused by pushing (pressing, squeezing) the manipulatable member.

According to this configuration, the discharge (dispensing) speed is changeable even without providing a change valve.

In another embodiment of the present disclosure, a manipulatable part, which is capable of instructing the controller to change the rotational speed of the rotary shaft, may be provided.

According to this configuration, the grease-discharging speed can be changed easily by manipulating (e.g., pressing, pushing, squeezing, etc.) the manipulatable part.

In another embodiment of the present disclosure, a discharge-amount display portion, which displays the grease-discharge amount attendant with the drive of the pump (i.e. the amount of grease that will be discharged or dispensed by driving the pump according to a set value), may be provided.

According to this configuration, the grease-discharge amount can be easily derived (calculated) by using a feature of the brushless motor, which performs rotational-speed detection by using the sensor circuit board.

In another embodiment of the present disclosure, a discharge-amount setting portion, which sets the total amount of the grease-discharge amount attendant with the drive of the pump (i.e. the total amount of grease that will be discharged or dispensed by driving the pump according to a set value), may be provided.

According to this configuration, it is possible to discharge (dispense) only the required discharge amount, thereby eliminating wasting of grease.

In another embodiment of the present disclosure: a fan may be mounted on the rotary shaft; and an air-intake opening, through which outside air is drawn when the fan is rotated, may be provided on either one of the battery-holding part and the motor housing, and an air-exhaust opening, which exhausts the drawn-in air, may be provided on the other.

According to this configuration, cooling of the controller and the motor can be performed effectively.

In another embodiment of the present disclosure, the controller may be configured/adapted to stop the motor when the total amount of the discharge amount set by the discharge-amount setting portion has been reached.

According to this configuration, wasteful discharging of grease can be reliably prevented.

### Working Example 1

Working examples of the present disclosure will be explained below, with reference to the drawings.

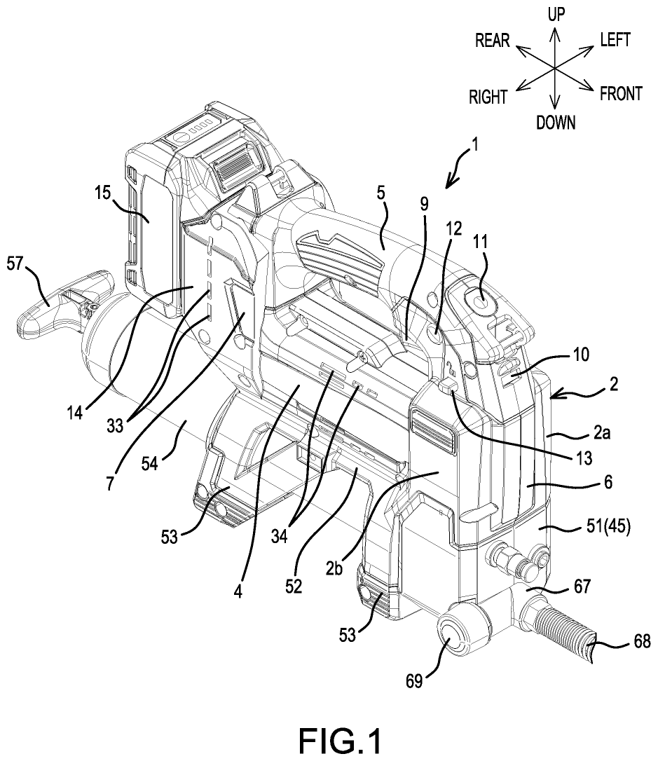

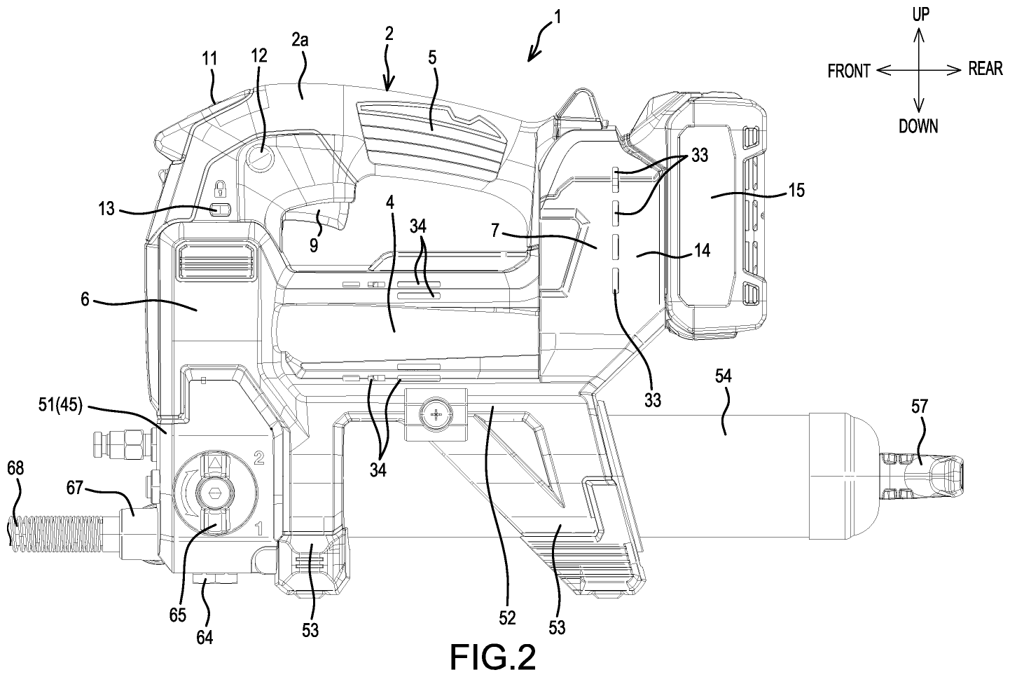

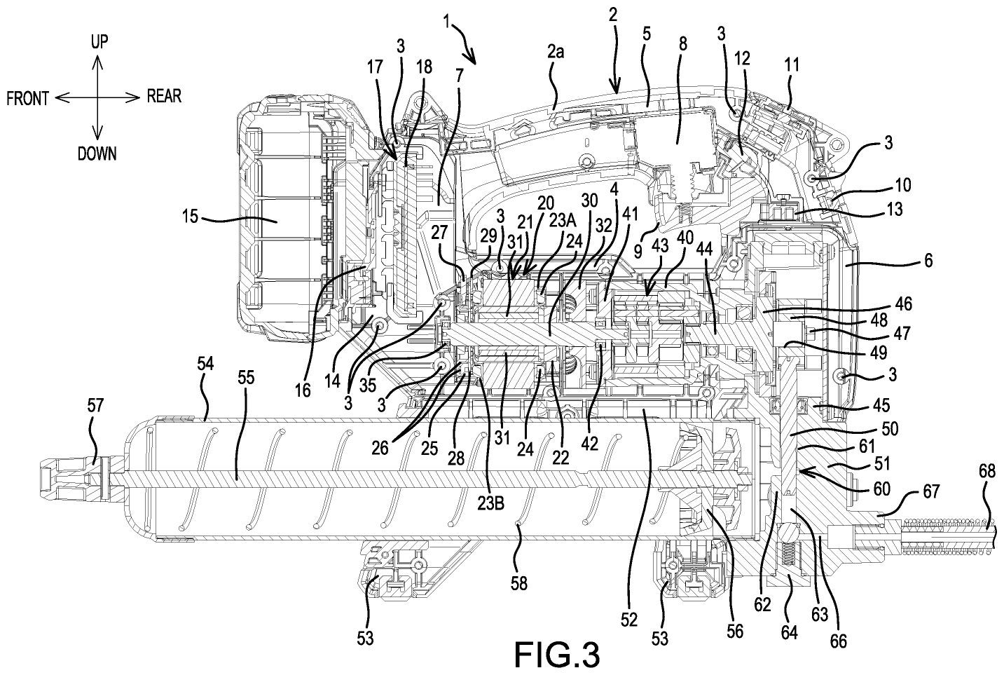

FIG. 1 is an oblique view that shows a rechargeable (cordless) grease gun 1, which is one representative, non-limiting example of a grease-discharging apparatus according to the present teachings. FIG. 2 is a side view of the grease gun, and FIG. 3 is a center, longitudinal, cross-sectional view of the grease gun.

The grease gun 1 comprises a housing 2. The housing 2 is constituted by assembling left and right half housings 2a, 2b using a plurality of screws 3. A tube-shaped motor-housing part 4 is formed in the front-rear direction at a center portion of the housing 2 in the up-down direction. A grip part 5 is formed in the front-rear direction at an upper portion of the housing 2. A front coupling part 6 is formed on the front side of the motor-housing part 4. A front end of the grip part 5, which bends downward, is coupled to the front coupling part 6. The rear side of the motor-housing part 4 constitutes a rear coupling part 7, which rises upward. The rear end of the grip part 5 is coupled to the rear coupling part 7 to form a loop shape.

A trigger switch 8 is housed in the interior of the grip part 5. The trigger switch 8 is connected to a trigger 9, which protrudes downward. A light 10, which may comprise one or more LEDs, is provided on a front surface of the grip part 5. A light switch 11, which switches the light 10 ON and OFF, is provided on an upper surface of a front portion of the grip part 5. A lock-on button (lock button) 12, which can maintain the pulled-in state of the trigger 9, is provided on the grip part 5 forward of the trigger 9. A lock-off button (trigger-lock button) 13, which restricts (blocks) the pulling of the trigger 9, is provided forward of the trigger 9 and downward of the lock-on button 12.

A battery-holding part (battery mounting part) 14 is formed on the rear side of the rear coupling part 7. A battery pack 15 (e.g., rated voltage of 36 V) is mountable, by sliding from above, on the rear side of the battery-holding part 14. A terminal block 16, to which the mounted battery pack 15 is electrically connected, is provided in the up-down direction in the interior of the battery-holding part 14. A controller 17 is provided in the up-down direction in the interior of the battery-holding part 14 on the front side of the terminal block 16. The controller 17 comprises a control circuit board 18, on which a microcontroller (which comprises one or more microprocessors, memory, input/output devices, etc.), switching devices (e.g., power MOSFETs), and the like are installed, and controls the light 10 and the operation of the motor 20, which is described below.

The motor 20 is housed in the interior of the motor-housing part 4. The motor 20 is an inner-rotor-type brushless motor comprising a stator 21 and a rotor 22, which is located in the interior of the stator 21.

The stator 21 has a plurality of (here, six) coils 24, 24, which are wound through insulators 23A, 23B provided on front- and rear-end surfaces. The rear-side insulator 23B comprises terminals (not shown), to which wires that form the coils 24 are fused, and a short-circuiting member (busbar(s)) 25. The short-circuiting member 25 is formed by insert-molding three short-circuiting metal fixtures or fitting (e.g., electrically conductive (e.g., metal) bars or strips) 26, to which three phases of power-supply wires 27 are respectively connected. By connecting the short-circuiting metal fixtures 26 to the power-supply wires 27 via respective terminals (fusing terminals), the coils 24 are wired in three phases. A sensor circuit board 28 is provided between the insulator 23B and the short-circuiting member 25. One or more rotation-detection devices (e.g., one or more Hall-effect devices), which acquire(s) the rotational position of the rotor 22, is (are) installed on the sensor circuit board 28, and a plurality of signal wires 29 is connected to the sensor circuit board 28. The power-supply wires 27 and the signal wires 29 are routed to the battery-holding part 14 side and are connected to the control circuit board 18 of the controller 17.

The rotor 22 comprises a rotary shaft 30 at its axial center. A plurality of permanent magnets 31 is embedded around the rotary shaft 30. A fan 32 is orthogonally mounted at/on a front portion of the rotary shaft 30.

A plurality of air-intake openings 33 is formed in left and right side surfaces of the rear coupling part 7. By rotating the fan 32, outside air is drawn in via the air-intake openings 33. A plurality of air-exhaust openings 34 is formed on left and right side surfaces of the motor-housing part 4. The air-exhaust openings 34 are located radially outward of the fan 32 and forward thereof and exhaust, to the outside, the air that was drawn into the interior of the motor-housing part 4.

A bearing 35, which supports a rear end of the rotary shaft 30, is provided in the interior of the rear coupling part 7 and rearward of the short-circuiting member 25.

A gear housing 40 is provided forward of the motor 20. The gear housing 40 has a tubular shape, and a bracket plate 41 is mounted in a rear-end opening thereof. The front end of the rotary shaft 30 passes through the bracket plate 41 and protrudes into the interior of the gear housing 40. The bracket plate 41 holds a bearing 42, which supports the rotary shaft 30.

A speed-reducing mechanism 43 is housed in the interior of the gear housing 40. The speed-reducing mechanism 43 uses planet gears to reduce, in three stages, the rotational speed of the rotary shaft 30 (while increasing torque) and outputs a reduced rotational speed (but higher torque) to a spindle 44, which is provided on the front end. A crank housing 45, which extends in the up-down direction, is provided at/on the front side of the gear housing 40. The spindle 44 protrudes from the gear housing 40 into the interior of the crank housing 45.

Within the crank housing 45, a crank disk 46 is integrally provided on the front end of the spindle 44. The crank disk 46 comprises an eccentric pin 47, which protrudes forward. A slider 48, which comprises a slotted hole 49 extending in the left-right direction, is provided forward of the crank disk 46. The slider 48 is supported inside the crank housing 45 in a manner so as to be movable upward and downward (i.e. in the up-down direction), and the eccentric pin 47 is inserted into the slotted hole 49. An upper end of a plunger 50, which has a rod shape extending in the up-down direction, is coupled to the center of the lower end of the slider 48.

Thereby, when the crank disk 46 rotates together with the spindle 44, the eccentric pin 47 undergoes eccentric motion. In so doing, the slider 48 moves up and down with a defined stroke length in the up-down direction of the eccentric pin 47, and the plunger 50 moves up and down integrally therewith.

A front holder 51, which has a circular-tube shape, is formed at a lower portion of the crank housing 45. A rear holder 52, which protrudes downward, is provided rearward of the front holder 51 at a lower portion of the motor-housing part 4. The rear holder 52 comprises front and rear leg parts 53.

A tank (barrel, e.g., a cartridge barrel) 54 is supported by the front holder 51 and the rear holder 52. The tank 54 is open at its front end, passes through the rear holder 52 from the rear, and its front end is screwed into a rear surface of the front holder 51. In this state, the tank 54 is coupled to the front holder 51 with an attitude (orientation) extending in the front-rear direction downward of the motor-housing part 4.

A rod 55, which has a piston 56 at its front end, is housed, in the interior of the tank 54, such that it is movable in the front-rear direction. The rear end of the rod 55 protrudes from the rear end of the tank 54 and is provided with a handle 57. A coil spring 58 is provided rearward of the piston 56 in the interior of the tank 54 and biases the piston 56 forward. In the interior of the tank 54, a cartridge (not shown), which is filled with grease, is housed on/at the front side of the piston 56. The cartridge is pressed by the piston 56, which is urged to advance forward owing to the bias (spring force) of the coil spring 58, and thereby the grease is supplied into the interior of the front holder 51.

A pump 60 is provided in the interior of the front holder 51. The pump 60 discharges (dispenses), under pressure, the grease supplied from the tank 54 in response to the up-down movement of the plunger 50. The pump 60 comprises, in addition to the plunger 50, an upper-tube part 61 and a lower-tube part 62. A gap between the upper-tube part 61 and the lower-tube part 62 fluidly communicates with the tank 54. A longitudinal, discharge path 63 is formed in the interior of the lower-tube part 62. A check valve 64 is provided at a lower portion of the longitudinal, discharge path 63. A change valve, which is not shown, is provided on the left side of the lower-tube part 62. By rotationally manipulating (manually rotating) a manipulatable knob (speed mode changing knob) 65, which is provided on a side surface of the front holder 51, the change valve can change, in two stages (high/low), the amount of grease that will be discharged or dispensed.

A lateral, discharge path 66, which fluidly communicates with the longitudinal, discharge path 63, is formed forward facing in the lower-tube part 62. A front-tube part 67, which protrudes forward, is formed on the front surface of the front holder 51. The lateral, discharge path 66 is formed in the center of the front-tube part 67, and its front end is open. A hose 68 is connected to the front-tube part 67. A relief valve (pressure relief valve) 69 is provided on the right side of the front-tube part 67. When the pressure of the grease inside the lateral, discharge path 66 becomes a prescribed pressure or greater, the relief valve 69 releases grease to the outside.

In the grease gun 1 configured as above, the trigger 9 is manipulated (pulled) in the state in which the tank 54, which houses the cartridge, is coupled to the front holder 51. In so doing, when the control circuit board 18 has detected the signal of the trigger switch 8, it supplies electric power (current) to the motor 20, thereby causing the rotary shaft 30 to rotate. That is, the microcontroller of the control circuit board 18 acquires the rotational state of the rotor 22 by obtaining one or more rotation-detection signals, which is (are) output from the rotation-detection device(s) of the sensor circuit board 28. Then, the microcontroller controls the ON/OFF state of each switching device in accordance with the acquired rotational state and supplies the three-phase current, in order, to the coils 24 of the stator 21, thereby causing the rotor 22 to rotate.

The rotational output of the rotary shaft 30 is supplied to the speed-reducing mechanism 43, which reduces the rotational speed while increasing torque, and the rotational output of the speed-reducing mechanism 43 is transmitted to the spindle 44, thereby causing the crank disk 46, together with the spindle 44, to rotate at a lower rotational speed than the (higher) rotational speed of the rotary shaft 30. Thereby, the eccentric pin 47 undergoes eccentric motion and the slider 48 moves up and down, thereby causing the plunger 50 to undergo reciprocal motion upward and downward. Thereby, with regard to the pump 60, the grease, which was pressed downward inside the longitudinal, discharge path 63 of the lower-tube part 62, flows into the lateral, discharge path 66 and is discharged through the hose 68. This discharge operation is performed repetitively in accordance with the reciprocating motion of the plunger 50. However, it is noted that the grease gun 1 is preferably configured such that the rotational speed of the rotary shaft 30 (i.e., the discharge speed of the grease) changes (is changeable or variable) in accordance with the amount of pull (the pull degree) of the trigger 9, as will be further described below.

Meanwhile, the fan 32 rotates owing to the rotation of the rotary shaft 30. In so doing, outside air is drawn in via the left and right air-intake openings 33 of the battery-holding part 14. The drawn-in air contacts the controller 17, thereby cooling the controller 17. Subsequently, the air contacts the power-supply wires 27 and the signal wires 29 inside the battery-holding part 14, thereby cooling the power-supply wires 27 and the signal wires 29. Subsequently, the air flows into the motor-housing part 4 and passes by the motor 20, thereby cooling the motor 20. Then, the air is discharged to the outside via the air-exhaust openings 34. The air discharged via the front-side air-exhaust openings 34 contacts the gear housing 40, thereby cooling the gear housing 40, after which the air is discharged to the outside. The crank housing 45 is also cooled.

The grease gun 1 according to Working Example 1 described above comprises: the motor 20; the pump 60, which is configured/adapted to be driven (drivable) by the motor 20; the motor-housing part 4 (one representative example of a motor housing), which houses the motor 20; the crank housing 45 (one representative example of a pump housing), which has (contains) the pump 60 and extends in the up-down direction; the tank 54, which supplies grease to the pump 60; and the front-tube part 67 (one representative example of a grease-discharge opening), which is provided at a front portion of the crank housing 45.

Furthermore, the front end of the tank 54 is connected (e.g., both physically connected (directly connected) and fluidly connected) to the pump 60 and extends in the front-rear direction, and the motor 20 is a brushless motor.

According to this configuration, the output of the motor 20 can be increased, thereby enabling high-speed discharge in a high-pressure range.

The motor 20 comprises: the stator 21; the rotor 22, which is disposed in the interior of the stator 21 and comprises the rotary shaft 30; and the sensor circuit board 28, which detects the rotational position of the rotor 22; and is housed in the interior of the motor-housing part 4 with an orientation (attitude) such that the rotary shaft 30 extends in the front-rear direction while (when, in the state in which) the motor-housing part 4 is disposed upward of the tank 54 and extends in the front-rear direction.

Thereby, the tank 54 and the motor-housing part 4, both of which extend in the front-rear direction, are disposed upward and downward (i.e. one above the other in the up-down direction), and thereby the left-right width of the grease gun 1 can be made more compact. The grip part 5, which extends in the front-rear direction and both front and rear ends of which are connected in a loop shape with the motor-housing part 4, is formed upward of the motor-housing part 4; the trigger switch 8, which drives the motor 20, and the trigger 9 (manipulatable member), which presses in the trigger switch 8, are provided on the grip part 5.

Thereby, the grip part 5 also extends in the front-rear direction upward of the motor-housing part 4 and thus is much more compact in the left-right direction, and the grease gun 1 also can be easily manipulated, handled, controlled, etc. using the grip part 5, which is located upward.

The battery-holding part 14, on which the battery pack 15 is mounted, is formed on the rear coupling part 7 (one example of a coupling portion), at which rear ends of the motor-housing part 4 and the grip part 5 are coupled to each other, and the controller 17, which controls the motor 20 based on the detection signal(s) of (from, output by) the sensor circuit board 28, is housed in the interior of the battery-holding part 14.

Thereby, front-rear balance is improved, and handling of the grease gun 1 becomes easy.

The fan 32 is mounted on the rotary shaft 30, the air-intake openings 33, through outside air is drawn (suctioned) when the fan 32 is rotated, are provided on the battery-holding part 14, and the air-exhaust openings 34, which discharge the drawn-in air, are provided on the motor-housing part 4.

Thereby, cooling of the controller 17 and the motor 20 can be performed effectively.

### Working Example 2

Next, another working example of the present disclosure will be explained. However, structural members the same as those in the previous Working Example 1 are assigned the same symbols or reference numerals, redundant explanations thereof are omitted, and the explanation will focus on those structural members that are different from Working Example 1.

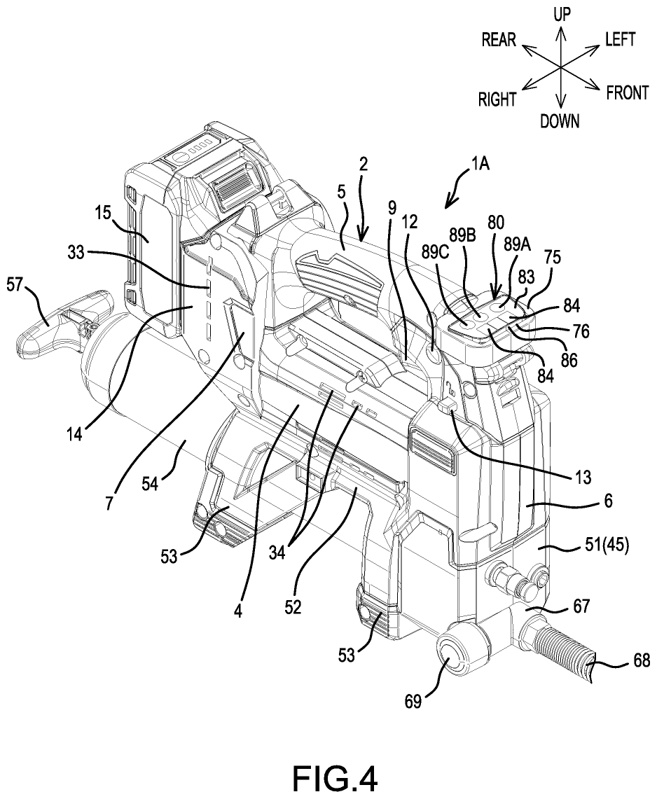

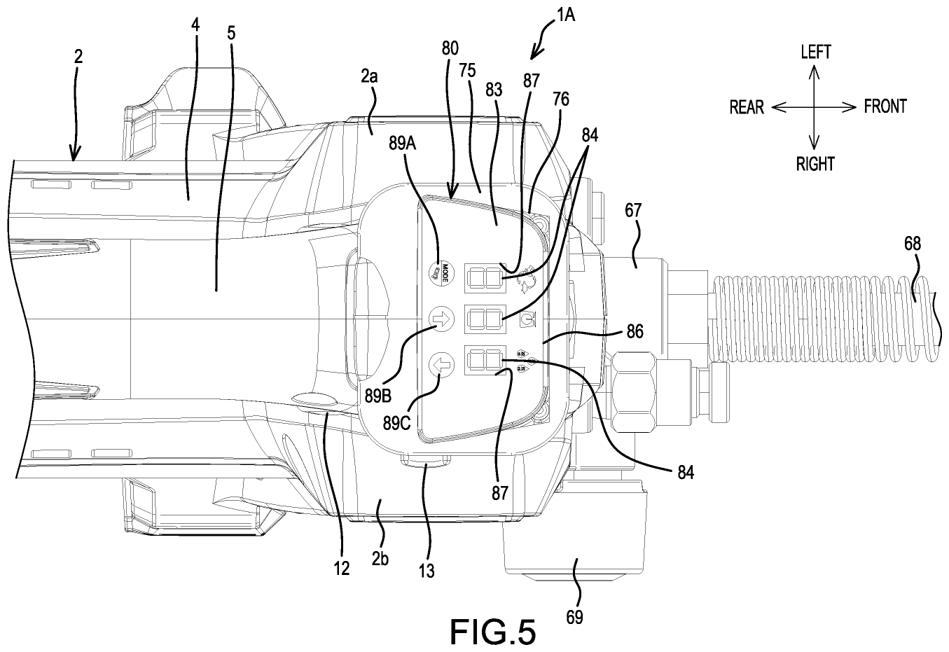

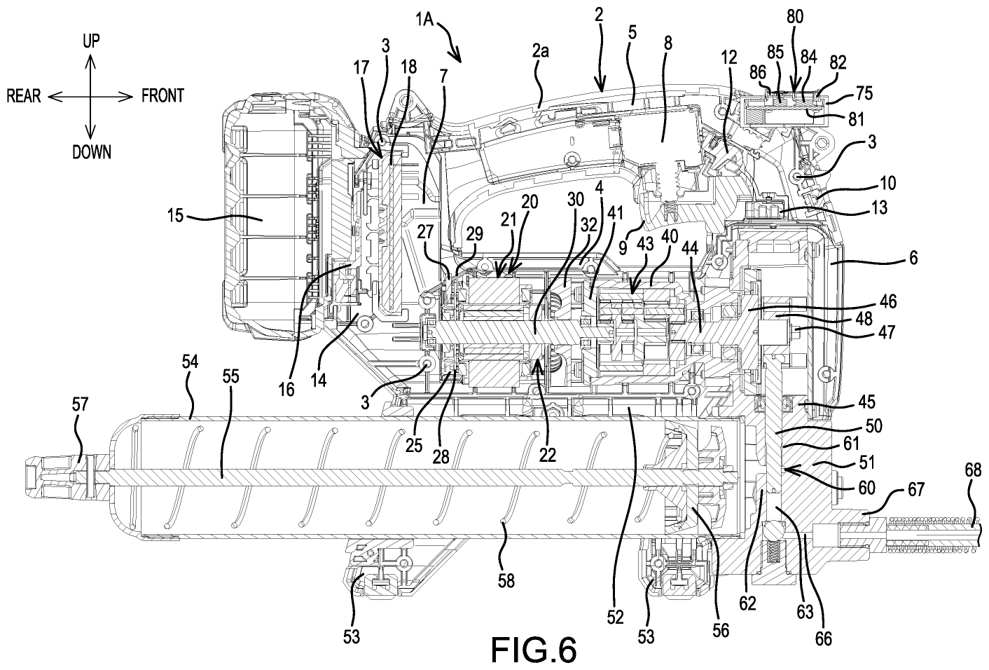

FIG. 4 is an oblique view of the grease gun 1A of Working Example 2, FIG. 5 is a partial, enlarged, plan view of the grease gun, and FIG. 6 is a center, longitudinal, cross-sectional view of the grease gun.

In the grease gun 1A, a change valve is not provided in the front holder 51.

Instead, the controller 17 of grease gun 1A is configured/adapted to detect the rotational speed of the motor 20 using the rotation-detection device(s) provided on the sensor circuit board 28. Thereby, a reciprocation count (i.e. a number of reciprocations) of the plunger 50 can be measured (counted) from (based on) the rotational speed, and thereby it becomes possible to measure (calculate) the grease-discharge amount by using the detected rotational speed. Consequently, the grease gun 1A is provided with an operation panel 80, which can change the grease-discharge speed and can thereby set the discharge amount.

A panel-holding part 75, which has an oblong, rectangular shape in plan view, is formed at a front portion of the upper surface of the grip part 5. On the front side of its upper surface, the panel-holding part 75 has an oblong opening 76. The operation panel 80 is provided at an upper portion of the panel-holding part 75.

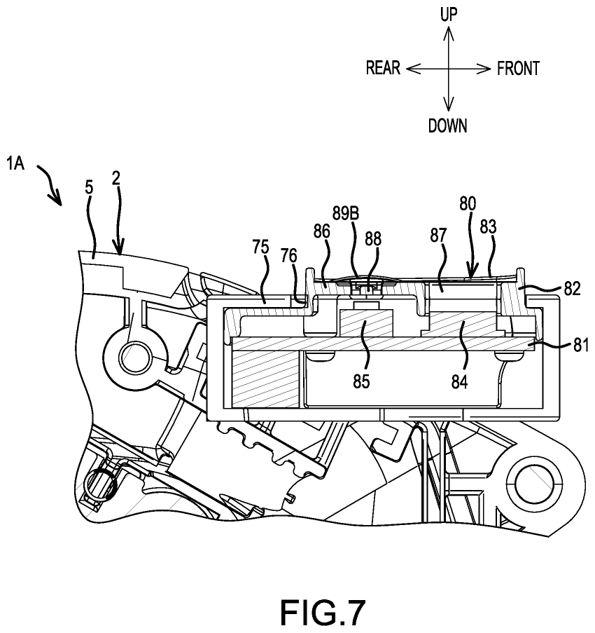

As shown also in FIG. 7, the operation panel 80 comprises a circuit board 81, a resin (polymer) plate 82 on the upper side thereof, and a display seal 83 on the upper side thereof.

The circuit board 81 has an oblong, rectangular shape in plan view that fits within the panel-holding part 75 and comprises, on its upper surface, three 7-segment displays 84 and three button switches 85. The 7-segment displays 84 are provided side by side in the left-right direction on/at the front side (front portion) of the circuit board 81. The button switches 85 are provided side by side in the left-right direction rearward of the 7-segment displays 84. The circuit board 81 is electrically connected to the controller 17 by lead wires, which are not shown.

The resin plate 82 covers, from above, the circuit board 81 inside the panel-holding part 75. The resin plate 82 comprises a display-plate part 86, which protrudes upward through the opening 76 of the panel-holding part 75. The display-plate part 86 comprises three square holes 87 and three elastic pieces 88. By respectively disposing the square holes 87 upward of the 7-segment displays 84, the display (illuminated image) of each of the 7-segment displays 84 is transmittable therethrough. The elastic pieces 88 are respectively disposed upward of the button switches 85 and are elastically deformable in the up-down direction. When the elastic pieces 88 are pressed downward, the button switches 85 can be turned ON and OFF.

The display seal 83 is translucent or transparent, is affixed to an upper surface of the display-plate part 86, and covers, from above, the square holes 87 and the elastic pieces 88. Circular, manipulatable parts 89A-89C are displayed upward of the elastic pieces 88, respectively.

As shown in FIG. 5, the left-side circular, manipulatable part 89A is a mode-changing button. Examples of modes include changing the discharge speed, displaying the discharge amount, and setting the discharge amount. The center circular, manipulatable part 89B is an increment (for incrementing) button that increments the numerical value of the 7-segment displays 84 when pressed. The right-side circular, manipulatable part 89C is a decrement (for decrementing) button that decrements the numerical value of the 7-segment displays 84 when pressed. Hereinbelow, the manipulatable parts 89A-89C are explained with reference to a mode-changing button, an increment button, and a decrement button, respectively. However, the mode-changing button 89A may optionally serve double duty as a light switch. The function of the mode-changing button 89A is changeable by performing a long press or the like.

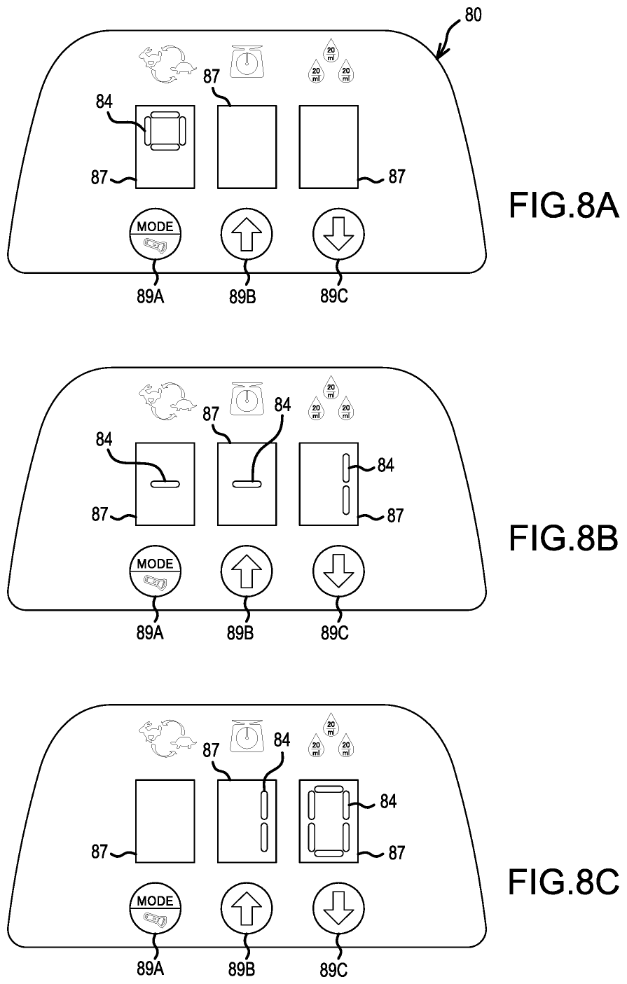

When the mode-changing button 89A of the operation panel 80 is pressed, a square (□) is turned ON (e.g., only the upper half of the numeric character 8 is turned on) at the location at which the 7-segment displays 84 indicate the current mode. That is, in case of the speed-change mode, a square is displayed on the left-side 7-segment display 84, as shown in FIG. 8A. In case of the discharge-amount display mode, a square is displayed on the center 7-segment display 84. In case of the discharge-amount setting mode, a square is displayed on the right-side 7-segment display 84. When the mode-changing button 89A is pressed once more, the mode changes to the next mode. For example, when the mode-changing button 89A is pressed in the speed-change mode, in which a square is displayed on the left-side 7-segment display 84, a square is then displayed on the center 7-segment display 84, and the mode changes to the discharge-amount display mode. When further pressed, the mode changes to the next mode; and when further pressed, the mode changes to the initial mode. Thus, with each pressing of the mode-changing button 89A, the location of the square of the 7-segment display 84 changes in the order of left→center→right→left . . . , and thus it is possible to change to the mode that corresponds to the location of the square. It is noted that, forward of the three 7-segment displays 84, icons (graphic symbols) indicating the modes are displayed (shown) on the display seal 83. An operator can recognize the selected mode by the correspondence between the icons and the position of the square.

When the increment button 89B is pressed in the speed-change mode, the numeric character of the 7-segment displays 84 is incremented by 1. (For example, when the increment button 89B is pressed in the state in which 1 is displayed on the right-side 7-segment display 84, as shown in FIG. 8B, the number 2 is then displayed on the right-side 7-segment display 84.) In addition, when the decrement button 89C is pressed in the speed-change mode, the numeric character of the 7-segment displays 84 is decremented by 1. (For example, when the decrement button 89C is pressed in the state in which 2 is displayed on the right-side 7-segment display 84, the number 1 is then displayed on the right-side 7-segment display 84.) Starting from the numeric character displayed in the speed-change mode, the rotational speed of the motor 20, i.e., the discharge speed of the grease, is changed within a range that is set in advance. When the amount of pull of the trigger 9 is changed at a set discharge speed, the discharge speed is changed in stages within the range set in advance.

In the discharge-amount display mode, the display of the 7-segment displays 84 is incremented by the amount of grease discharged in accordance with the set discharge speed and the amount of pull of the trigger 9. After the right-side 7-segment display 84 has been incremented from 1 to 9, as shown in FIG. 8C, the center 7-segment display 84 becomes 1 and the right-side 7-segment display 84 becomes 0, and thereby 10 is displayed. Thus, up to 999 is displayed. The numeric character 1 indicates, e.g., 1 g (or another appropriate amount of grease in terms of mass or volume). In the discharge-amount display mode, the grease-discharge amount can be known.

In addition, when the increment button 89B or the decrement button 89C is pressed in the discharge-amount display mode, the numeric character displayed is reset, and 0 is displayed on the right-side 7-segment display 84.

When the increment button 89B is pressed in the discharge-amount setting mode, the numeric character of the right-side 7-segment display 84 is incremented by 1 (e.g., when the increment button 89B is pressed in the state in which 1 is displayed on the right-side 7-segment display 84, the number 2 is then displayed on the right-side 7-segment display 84). After the right-side 7-segment display 84 has been incremented from 1 to 9, in the same manner as in FIG. 8C, the center 7-segment display 84 becomes 1 and the right-side 7-segment display 84 becomes 0, and thereby 10 is displayed. In addition, when the decrement button 89C is pressed in the discharge-amount setting mode, the numeric character of the right-side 7-segment display 84 is decremented by 1 (e.g., when the decrement button 89C is pressed in the state in which 2 is displayed on the right-side 7-segment display 84, the number 1 is then displayed on the right-side 7-segment display 84). After the right-side 7-segment display 84 has been decremented from 9 to 1, the center 7-segment display 84 is decremented by 1 and the right-side 7-segment display 84 becomes 0. It is noted that, when the increment button 89B or the decrement button 89C is long-pressed, the speed at which the numeric character increments or decrements quickens. In so doing, it is settable from 0 to 200. The numeric character 1 indicates 1 g (or another appropriate measure of the amount of grease that is dispensed). Thereby, when the trigger 9 is pulled from 200 and 1 g is discharged, the display changes to 199. That is, an amount of grease is discharged commensurate with the number of pulls of the trigger 9, and the display decrements correspondingly. When the display becomes 0, the motor 20 stops even if the trigger 9 is pulled. In the discharge-amount display mode, only the set discharge amount (total amount) can be discharged.

Thus, in the grease gun 1A according to the above-mentioned Working Example 2 as well, owing to the use of the motor 20, which is a brushless motor, the motor output can be sufficiently increased to enable high-speed discharge (dispensing) in the high-pressure range.

In particular, the controller 17 can be configured/adapted to control the rotational speed of the rotary shaft 30 based on the push-in amount of the trigger switch 8 caused by manipulating (e.g., pressing, pushing, squeezing, etc.) the trigger 9 (one representative example of a manipulatable member), and thereby can change the speed of the grease discharged (dispensed, output) by the pump 60.

Thereby, the discharge (dispensing) speed is changeable even without providing the change valve.

The operation panel 80 (one representative example of a manipulatable part), which is capable of instructing the controller 17 to change the rotational speed of the rotary shaft 30, is provided.

Thereby, the grease-discharge speed can be changed easily by manipulating (e.g., pressing one or more buttons on) the operation panel 80.

A function that displays the grease-discharge amount attendant with the drive of the pump 60 (one representative example of a discharge-amount display portion according to a first configuration and a representative display portion according to a second configuration) is provided on the operation panel 80.

Thereby, the grease-discharge amount can be easily derived (calculated) by measuring the reciprocation count (counting the number of reciprocations) of the plunger 50 using the feature of the brushless motor 20, which performs rotational-speed detection by using the sensor circuit board 28.

A function that sets the total amount of the grease-discharge amount attendant with the drive of the pump 60 (one representative example of a discharge-amount setting portion according to the first configuration and a representative setting portion according to the second configuration) is provided on the operation panel 80.

Thereby, it is possible to discharge (dispense, output) only the required discharge amount, thereby eliminating wasting of grease.

When the total amount of the discharge amount set by the operation panel 80 has been reached, the controller 17 stops the motor 20.

Thereby, wasteful discharge of grease can be reliably stopped.

In the above-mentioned Working Example 2, the configuration of the operation panel can be modified in a variety of ways.

For example, in the above-described Working Examples 1 and 2, the 7-segment displays are disposed on the front side, and the button switches are disposed on the rear side; however, reversely, the 7-segment displays may be disposed on the rear side, and the button switches may be disposed on the front side. The resin (polymer) plate and the display seal are also forward/rearward reversed accordingly.

The display of the operation panel is not limited to 7-segment displays. A display implemented by liquid crystals, lamps, other types of LED structures, and the like are also possible. It is also conceivable to supplement the controller with a communications function and to perform operation using a linked application provided on (e.g., an “app” executed by) an external terminal such as a smart phone, tablet computer, etc.

The display of the discharge speed and the discharge amount and the setting of the discharge amount may be performed by a setting method and a displaying method other than those described in the above-mentioned examples. It is also possible to omit any one or two.

When the motor is to be stopped because the discharge (dispensing) amount has become the set total discharge amount, braking is applied to the motor electrically; however, because it takes time until the motor stops, there is a possibility that grease will be excessively output beyond the set amount. In addition, with regard to the motor according to the above-mentioned Working Example 2, because the rotational speed of the motor can be adjusted (varied) by varying the amount of pull of the trigger or by manipulating buttons on the operation panel, there is a possibility that the amount of grease will increase or decrease relative to the set amount unless the stop time of the motor caused by the braking is accurately controlled.

Accordingly, the methods (1) and (2) below may be utilized to accurately stop the motor when the set discharge amount has been discharged (dispensed, output).

(1) In correspondence to the rotational speed (rotational speed) of the motor, the time from when the braking (which tends not to be mechanically and electrically loaded) is applied until the motor stops is stored in advance in the controller, and the time at which the electronic braking starts to be applied is controlled (set) in accordance with one or more operator usage conditions (e.g., the amount of pull of the trigger or the setting input to/at the operation panel). According to this method, it is possible to accurately stop at the set discharge amount by initiating the electronic braking of the motor just prior to the set discharge amount having been dispensed.

(2) To accurately stop at the set discharge amount, i.e., at a set total number of revolutions of the motor, the motor speed starts to be reduced before the total number of revolutions is reached (sooner than when the braking originally started to be applied). According to this method, the motor can be reliably stopped at the target total number of revolutions.

Modified examples common to Working Examples 1, 2 are explained below.

The battery-holding part (battery mounting part) is not limited to a structure in which the grip part and the motor-housing part are formed integrally. For example, the battery-holding part may be formed separately from the grip part and the motor-housing part, and one or more cushioning members, such as a rubber piece or another elastic or elastomeric material, may be interposed between the battery-holding part on one side and the grip part and the motor-housing part on the other. In so doing, impacts applied to the battery pack can be mitigated (absorbed) by the cushioning member(s), and thus the application of a large external force to the battery pack can be effectively prevented. Impacts to the battery-holding part are also mitigated (absorbed) by the cushioning member(s).

A receiving portion, which is located on the lower side of the battery pack mounted on the battery-holding part and that is proximate to or abuts a lower surface of the battery pack, may be provided at a rear portion of the housing. According to this configuration, if the grease gun is dropped during transport or work, it is possible to mitigate the impact applied by the external force to the battery pack.

A plurality of the battery packs may be mounted on the cordless grease gun 1 (e.g., using a plurality of battery-holding parts). In the alternative, the grease-discharging apparatus may be configured as an AC-powered tool that does not use a battery pack, but instead has a power cord that is connectable to a commercial AC power source.

The grease-discharging apparatus is not limited to releasing the pressure inside the discharge path using a relief valve. For example, instead of a relief valve, the controller may monitor the electric current that flows to the motor and, when the pressure inside the discharge path reaches a prescribed electric-current value corresponding to the discharge pressure at which the relief valve would actuate, the controller may perform control so as to stop the rotation of the motor.

The layout of the structural members, such as the motor, can also be modified as appropriate. Modified examples of the layout are explained below.

In each of the drawings, the structural members of the grease gun are shown schematically by square boxes, and the housing is indicated by chain, double-dashed lines. Solid lines indicate wiring, and dashed lines indicate the flows of air drafts (airflows) that are generated by the rotation of the fan.

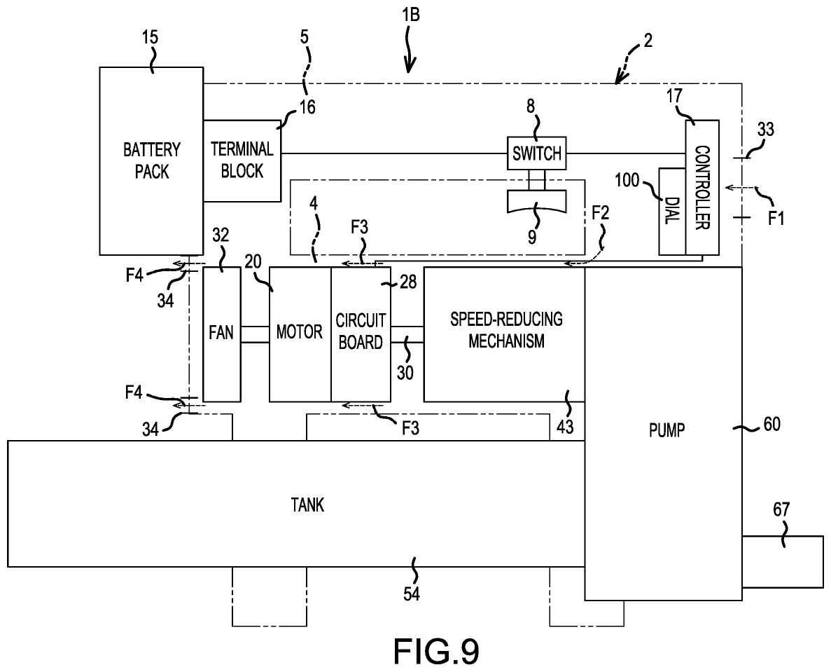

In the grease gun 1B shown in FIG. 9, an example is shown in which the fan 32 is disposed rearward of the motor 20, and the controller 17 is disposed at a front portion of the housing 2. A dial 100 is provided on the controller 17. The dial 100 is exposed at a side surface of the housing 2 and can be rotationally manipulated (manually rotated) from the outside. The dial 100 substitutes for the discharge-amount set button and can set the total amount of the discharge amount by rotational manipulation (manually rotation).

Because the fan 32 is located at a rear portion of the housing 2, the air-intake openings 33 are provided forward of the controller 17, and the air-exhaust openings 34 are provided rearward and radially outward of the fan 32. Thereby, when the fan 32 is rotated, the outside air that is drawn in via the air-intake openings 33, as indicated by dashed-line arrow F1, contacts and cools the controller 17, after which the air flows through the interior of the motor-housing part 4 in the order of F2 and F3, cools the speed-reducing mechanism 43 and the motor 20, and then is exhausted as F4 via the air-exhaust openings 34.

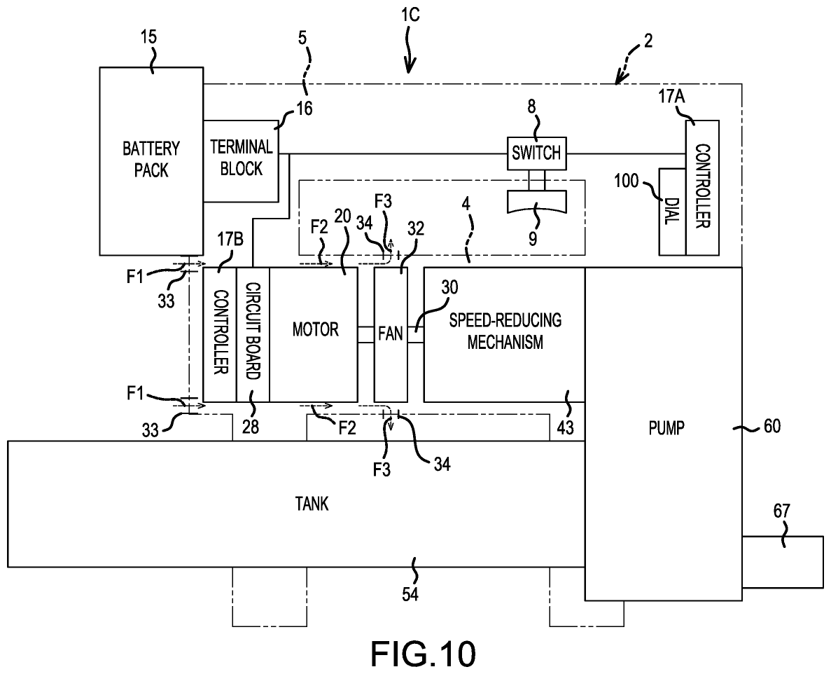

In the grease gun 1C shown in FIG. 10, the controller is divided into a forward portion and a rearward portion. The same as in FIG. 9, the microcontroller, the dial 100, etc. are installed on controller 17A, which is forward. The controller 17B, which is rearward, is disposed rearward of the sensor circuit board 28. The switching devices are installed on the controller 17B. Here, the fan 32 is disposed forward of the motor 20, the air-intake openings 33 are disposed rearward of the controller 17B, and the air-exhaust openings 34 are disposed radially outward of the fan 32. Thereby, when the fan 32 is rotated, the outside air that is drawn in via the air-intake openings 33, as indicated by F1, cools the controller 17B, after which the air flows through the interior of the motor-housing part 4 as F2, cools the motor 20, and then is exhausted via the air-exhaust openings 34 as F3.

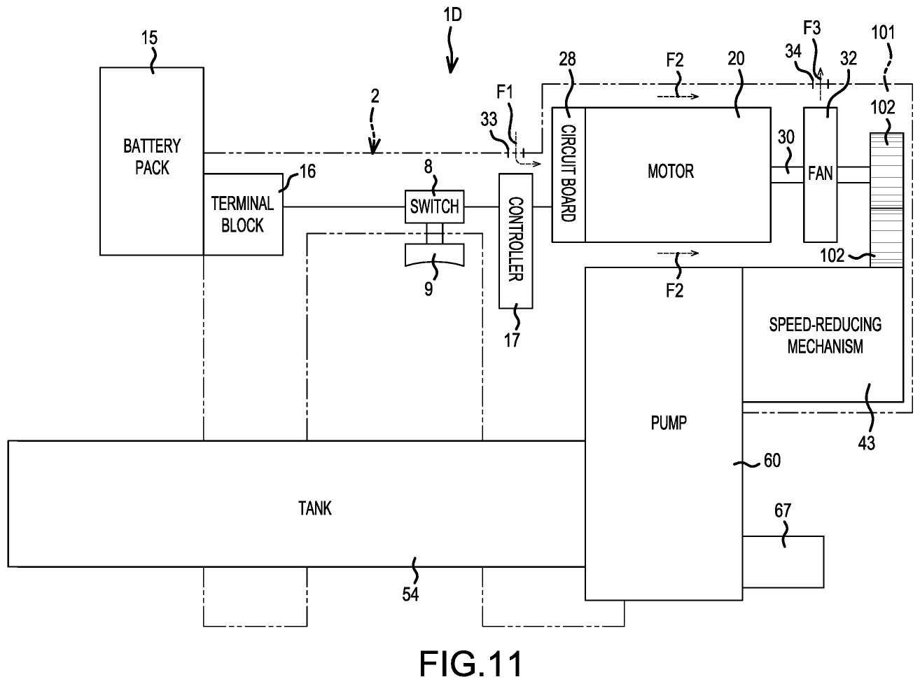

In the grease gun 1D shown in FIG. 11, the motor 20 is disposed at a front portion of the housing 2 and upward of the pump 60 contained in a pump housing 101. The speed-reducing mechanism 43 is disposed forward of the pump 60, and the transmission of rotation from the rotary shaft 30, which has the fan 32 at its front portion, is performed by two gears 102.

The controller 17 is disposed rearward of the motor 20, and the air-intake openings 33 are provided outwardly left and right or upward of the controller 17. The air-exhaust openings 34 are provided radially outward of the fan 32. Thereby, when the fan 32 is rotated, the outside air that is drawn in via the air-intake openings 33, as indicated by F1, cools the controller 17, after which it flows through the interior of the housing 2 as F2, cools the motor 20, and then is exhausted as F3 via the air-exhaust openings 34.

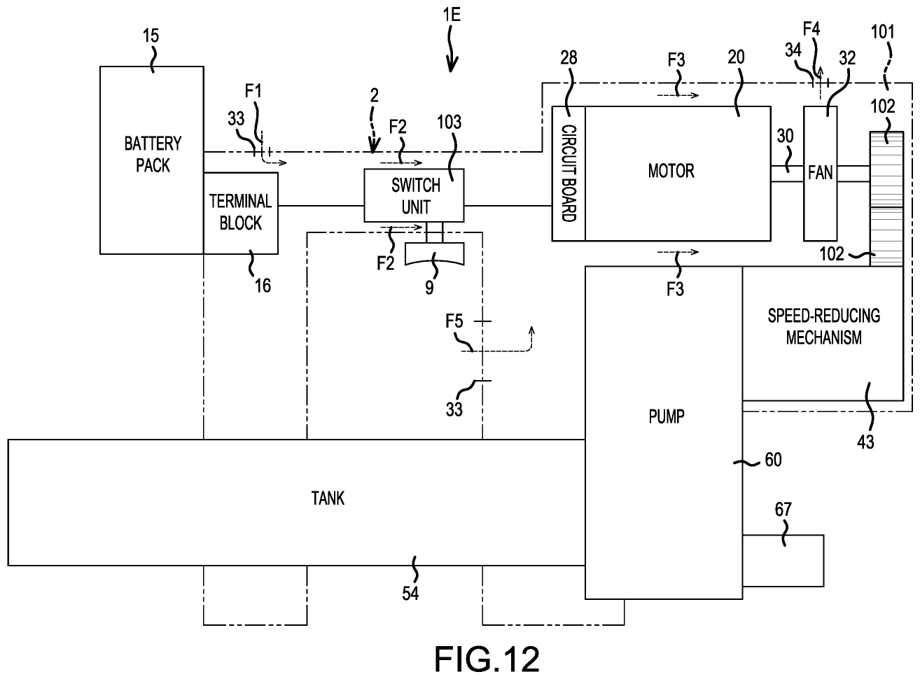

In the grease gun 1E shown in FIG. 12, the point of difference from FIG. 11 is that a switch unit 103, in which the controller is integrated with the trigger switch, is used. In addition, the air-intake openings 33 are provided forward of the terminal block 16 and rearward of the pump housing 101. Thereby, when the fan 32 is rotated, the outside air that is drawn in via the rearward air-intake openings 33, as indicated by F1, flows through the interior of the housing 2 as F2, and passes through and cools the switch unit 103, after which it flows through the interior of the housing 2 as F3, cools the motor 20, and then is exhausted as F4 via the air-exhaust openings 34. The outside air that is drawn in via the forward air-intake openings 33, as indicated by F5, rises up through the interior of the pump housing 101, merges with F3, and cools the motor 20, after which it is exhausted as F4 via the air-exhaust openings 34.

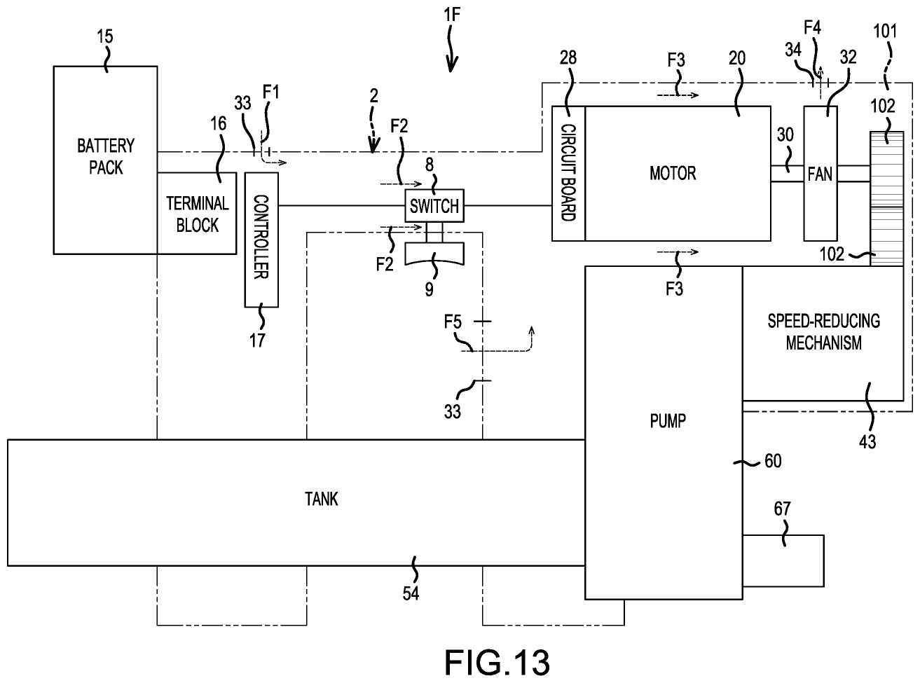

In the grease gun 1F shown in FIG. 13, the point of difference from FIG. 11 is that the controller 17 is disposed forward of the terminal block 16. The air-intake openings 33 are provided upward of and/or leftward and rightward of the controller 17 and rearward of the pump housing. Thereby, when the fan 32 is rotated, the outside air that is drawn in via the rearward air-intake openings 33, as indicated by F1, cools the controller 17, after which the air flows through the interior of the housing 2 in the order of F2 and F3, cools the trigger switch 8 and the motor 20 in order, and then is exhausted as F4 via the air-exhaust openings 34. The outside air that is drawn in via the forward air-intake openings 33, as indicated by F5, rises up through the interior of the pump housing 101, merges with F3, and cools the motor 20, after which it is exhausted as F4 via the air-exhaust openings 34.

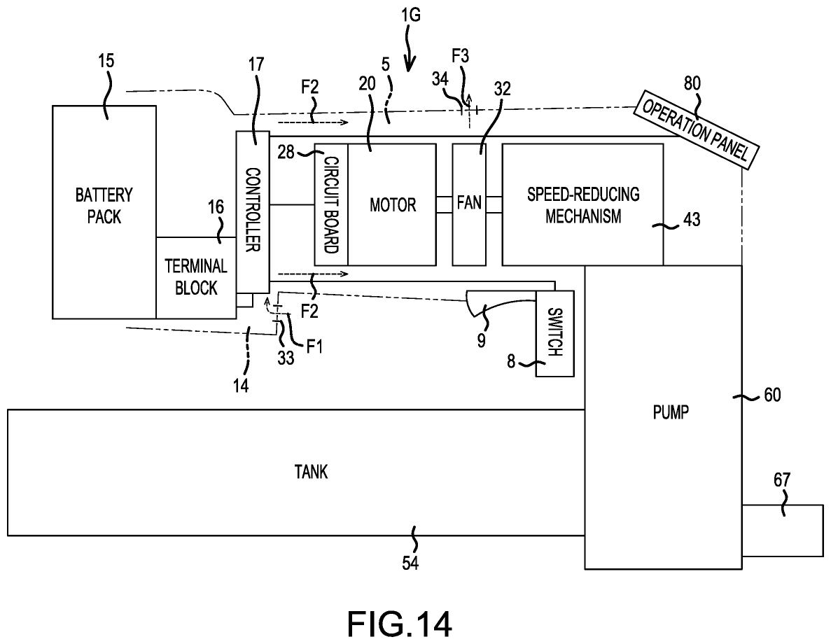

In the grease gun 1G shown in FIG. 14, the point of difference with the above-mentioned working examples and modified examples is that the motor 20 and the speed-reducing mechanism 43 are disposed in the interior of the grip part 5. The grip part 5 has a rearward-tapered shape in which the outer diameter gradually becomes smaller (decreases) as it goes (extends) rearward. The motor 20 is housed rearward in the interior of the grip part 5 and is housed in the front-rear direction with an orientation such that the sensor circuit board 28 is rearward and the fan 32 is forward. The battery-holding part 14, which extends in the up-down direction, is formed on the rear end of the grip part 5. The controller 17 is housed in the up-down direction forward of the terminal block 16 in the interior of the battery-holding part 14. The air-intake openings 33 are formed in the battery-holding part 14 on the front side of a lower portion of the controller 17.

The speed-reducing mechanism 43 is disposed forward of the motor 20 in the interior of the grip part 5. The trigger switch 8 is disposed downward of the speed-reducing mechanism 43 and rearward of the pump 60. The same as in the working examples, the operation panel 80 is disposed, with an attitude that is tilted lower in the front, on the front surface of a front portion of the grip part 5.

Thereby, when the fan 32 is rotated, the outside air that is drawn in via the rearward air-intake openings 33, as indicated by F1, cools the controller 17, after which it flows forward as F2 through the interior of the grip part 5. Subsequently, the air passes through and cools the sensor circuit board 28 and the motor 20 in order, after which the air is exhausted as F3 via the air-exhaust openings 34.

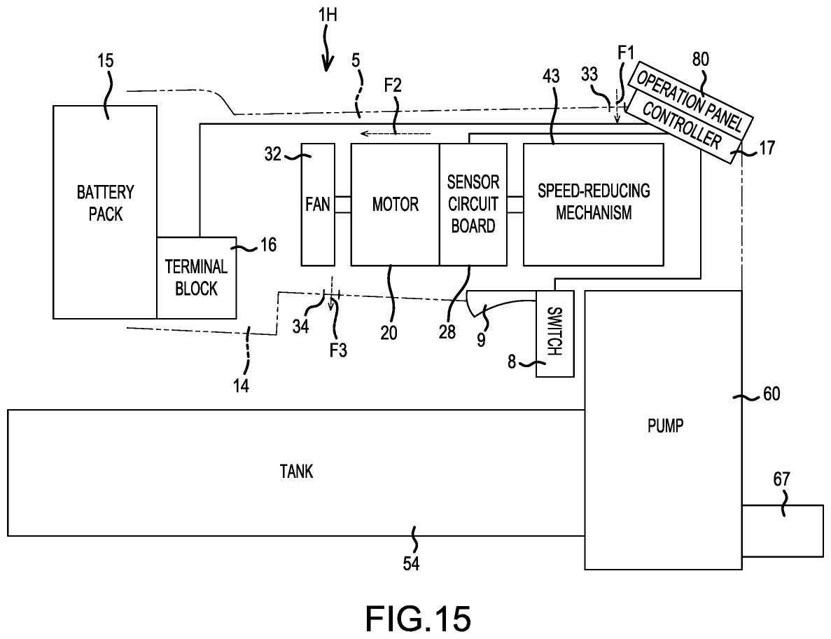

In the grease gun 1H shown in FIG. 15, the points of difference with FIG. 14 are that the orientation of the motor 20 is forward/rearward reversed and that the controller 17 is disposed downward of the operation panel 80 and likewise with an attitude that is tilted lower in the front. Thereby, the air-intake openings 33 are provided at/in a front portion of the grip part 5 and sideward of the left and right side surfaces of the controller 17. The air-exhaust openings 34 are provided at/in the rear end of the grip part 5.

Thereby, when the fan 32 is rotated, the outside air that is drawn in via the forward air-intake openings 33, as indicated by F1, cools the controller 17, after which it flows rearward through the interior of the grip part 5 as F2. Subsequently, the air passes through and cools the sensor circuit board 28 and the motor 20 in order, after which the air is exhausted as F3 via the air-exhaust openings 34.

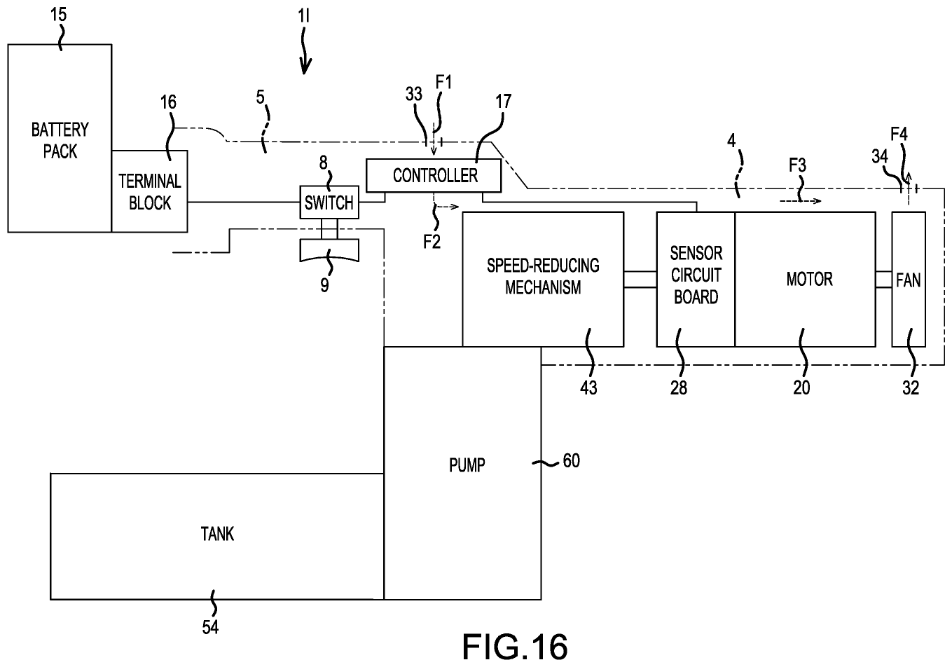

In the grease gun 1I shown in FIG. 16, the point of difference with the above-mentioned working examples and modified examples is that the motor-housing part 4, which protrudes more forward than the pump 60, is formed in the front-rear direction on the front end of the grip part 5. The trigger switch 8 is housed at an intermediate portion in the interior of the grip part 5, and the controller 17 is housed forward thereof in the front-rear direction. The air-intake openings 33 are provided upward of the controller 17.

The motor 20 is disposed at/in a front portion in the interior of the motor housing 4 with a forward/rearward orientation such that the rear side is the sensor circuit board 28 and the front side is the fan 32. The speed-reducing mechanism 43 is disposed rearward of the motor 20 in the interior of the motor-housing part 4.

Thereby, when the fan 32 is rotated, the outside air that is drawn in via the rearward air-intake openings 33, as indicated by F1, cools the controller 17, after which the air flows forward through the interior of the grip part 5 as F2 and F3. Subsequently, the air passes through and cools the speed-reducing mechanism 43, the sensor circuit board 28, and the motor 20, in order, and then is exhausted as F4 via the air-exhaust openings 34.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved grease-discharging devices, such as grease guns.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Although some aspects of the present disclosure have been described in the context of a device, it is to be understood that these aspects also represent a description of a corresponding method, so that each block or component of a device, such as the controller 17, is also understood as a corresponding method step or as a feature of a method step. In an analogous manner, aspects which have been described in the context of or as a method step also represent a description of a corresponding block or detail or feature of a corresponding device, such as the controller 17.

Depending on certain implementation requirements, exemplary embodiments of the controller 17 or controlling means of the present disclosure may be implemented in hardware and/or in software. The implementation can be configured using a digital storage medium, for example one or more of a ROM, a PROM, an EPROM, an EEPROM or a flash memory, on which electronically readable control signals (program code) are stored, which interact or can interact with a programmable hardware component such that the respective method is performed.

A programmable hardware component can be formed by a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor.

The digital storage medium can therefore be machine- or computer readable. Some exemplary embodiments thus comprise a data carrier or non-transient computer readable medium which includes electronically readable control signals which are capable of interacting with a programmable computer system or a programmable hardware component such that one of the methods described herein is performed. An exemplary embodiment is thus a data carrier (or a digital storage medium or a non-transient computer-readable medium) on which the program for performing one of the methods described herein is recorded.

In general, exemplary embodiments of the present disclosure, in particular the controller 17 or controlling means, are implemented as a program, firmware, computer program, or computer program product including a program, or as data, wherein the program code or the data is operative to perform one of the methods if the program runs on a processor or a programmable hardware component. The program code or the data can for example also be stored on a machine-readable carrier or data carrier. The program code or the data can be, among other things, source code, machine code, bytecode or another intermediate code.

A program according to an exemplary embodiment can implement one of the methods during its performing, for example, such that the program reads storage locations or writes one or more data elements into these storage locations, wherein switching operations or other operations are induced in transistor structures, in amplifier structures, or in other electrical, optical, magnetic components, or components based on another functional principle. Correspondingly, data, values, sensor values, or other program information can be captured, determined, or measured by reading a storage location. By reading one or more storage locations, a program can therefore capture, determine or measure sizes, values, variable, and other information, as well as cause, induce, or perform an action by writing in one or more storage locations, as well as control other apparatuses, machines, and components, and thus for example also perform complex processes using the electric motor 8 and other mechanical structures of the power tool.

Therefore, although some aspects of the controller 17 have been identified as “parts” or “units” or “steps”, it is understood that such parts or units or steps need not be physically separate or distinct electrical components, but rather may be different blocks of program code that are executed by the same hardware component, e.g., one or more microprocessors.

### EXPLANATION OF THE REFERENCE NUMBERS

1, 1A-1I Grease guns
2 Housing
4 Motor-housing part
5 Grip part
6 Front coupling part
7 Rear coupling part
8 Trigger switch
9 Trigger
10 Light
17 Controller
18 Control circuit board
20 Motor
21 Stator
22 Rotor
30 Rotary shaft
32 Fan
43 Speed-reducing mechanism
44 Spindle
50 Plunger
54 Tank
60 Pump
75 Panel-holding part
80 Operation panel
81 Circuit board
82 Resin plate
83 Display seal
86 Display-plate part
89A-89C Circular, manipulatable parts

1. A grease-discharging apparatus comprising:
a brushless motor;
a pump is configured to be drivable by the brushless motor;
a motor housing, which houses the brushless motor;
a pump housing, which contains the pump and extends in an up-down direction;
a tank configured to supply grease to the pump; and
a grease-discharge opening provided at a front portion of the pump housing;
wherein a front end of the tank is connected to the pump and extends in a front-rear direction that is perpendicular to the up-down direction.

2. The grease-discharging apparatus according to claim 1, wherein:
the motor housing is disposed upward of the tank and extends in the front-rear direction; and
the brushless motor comprises a stator, a rotor, which is disposed in the interior of the stator and comprises a rotary shaft, and a sensor circuit board, which is configured to detect the rotational position of the rotor, and is housed in the interior of the motor housing with an orientation such that the rotary shaft extends in the front-rear direction.

3. The grease-discharging apparatus according to claim 2, wherein:
a grip part, which extends in the front-rear direction and of which both front and rear ends are connected to the motor housing in a loop shape, is formed upward of the motor housing; and
a trigger switch, which is configured to control operation of the brushless motor, and a manipulatable member, which is configured to be manually pressed to apply pressure to the trigger switch, are provided in and/or on the grip part.

4. The grease-discharging apparatus according to claim 3, wherein:
a battery-holding part, on which a battery pack is mountable, is formed at and/or on a coupling portion at which rear ends of the motor housing and the grip part are coupled to each other; and
a controller, which is configured to control the brushless motor based on one or more detection signals output by the sensor circuit board, is housed in the interior of the battery-holding part.

5. The grease-discharging apparatus according to claim 4, wherein the controller is configured to change the discharge speed of grease discharged by the pump by controlling the rotational speed of the rotary shaft based on the push-in amount of the trigger switch caused by manually pressing the manipulatable member.

6. The grease-discharging apparatus according to claim 5, further comprising a manipulatable part configured to instruct the controller to change the rotational speed of the rotary shaft.

7. The grease-discharging apparatus according to claim 5, further comprising a discharge-amount display portion configured to display an amount of grease to be discharged by driving the pump.

8. The grease-discharging apparatus according to claim 5, further comprising a discharge-amount setting portion configured to set a total amount of grease to be discharged by driving the pump.

9. The grease-discharging apparatus according to claim 4, further comprising:
a fan mounted on the rotary shaft; and
an air-intake opening, through which outside air is drawn when the fan is rotated, provided in a first one of the battery-holding part and the motor housing, and an air-exhaust opening, which exhausts the drawn-in air, provided in a second one of the battery-holding part and the motor housing.

10. The grease-discharging apparatus according to claim 8, wherein the controller is configured to stop the brushless motor in response to reaching the total amount of grease to be discharged that was set by the discharge-amount setting portion.

11. The grease-discharging apparatus according to claim 1, further comprising:
a setting portion configured to set an amount of grease to be discharged.

12. The grease-discharging apparatus according to claim 1, further comprising:
a display configured to display an amount of grease to be discharged.

13. The grease-discharging apparatus according to claim 6, further comprising a discharge-amount display portion configured to display a total amount of grease to be discharged by driving the pump.

14. The grease-discharging apparatus according to claim 13, further comprising a discharge-amount setting portion configured to set the total amount of grease to be discharged by driving the pump.

15. The grease-discharging apparatus according to claim 14, further comprising:
a fan mounted on the rotatory shaft; and
an air-intake opening, through which outside air is drawn when the fan is rotated, provided in a first one of the battery-holding part and the motor housing, and an air-exhaust opening, which exhausts the drawn-in air, provided in a second one of the battery-holding part and the motor housing.

16. The grease-discharging apparatus according to claim 15, wherein the controller is configured to stop the brushless motor in response to reaching the total amount of grease to be discharged that was set by the discharge-amount setting portion.
